(19) United States
(12) Patent Application Publication
(10) Pub. No.: US 2013/0028489 A1
(43) Pub. Date: Jan. 31, 2013

(54) METHOD AND APPARATUS FOR DETERMINING POTENTIAL MOVEMENT DISORDER USING SENSOR DATA

(71) Applicants: Kenneth Tracton, Palo Alto, CA (US); Jörg Brakensiek, Mountain View, CA (US)

(72) Inventors: Kenneth Tracton, Palo Alto, CA (US); Jörg Brakensiek, Mountain View, CA (US)

(73) Assignee: Nokia Corporation, Espoo (FI)

(21) Appl. No.: 13/194,203

(22) Filed: Jul. 29, 2011

(51) Int. Cl. G06K 9/00

(52) U.S. Cl. 382/128

(57) ABSTRACT

An approach is provided for determining potential movement disorder using sensor data. The health and wellness engine processes and/or facilitates a processing of one or more sequences of images to identify one or more reference objects, the one or more sequences of images captured via a device physically attached to a user. The health and wellness engine determines movement information of the one or more reference objects within the one or more sequences of images, wherein the movement information is at least substantially attributable to one or more physical movements of the user. The health and wellness engine processes and/or facilitates a processing of the movement information to cause, at least in part, a determination of one or more potential movement disorders associated with the user.

### BACKGROUND

Service providers and device manufacturers (e.g., wireless, cellular, etc.) are continually challenged to deliver value and convenience to consumers by, for example, providing compelling network services. These network services may generate revenue by offering services promoting health and wellness of users. Examples of such services include messaging and tracking users' health data, messaging and tracking users' sport activity data, healthcare social networking services, health and wellness media services, health and wellness service/product purchasing services, and the like. There are existing online symptom and diagnose determining systems to guide a user to select parts of the body that experience symptoms. However, the systems rely upon the user to judge applicable symptoms and cannot determine early symptoms of diseases (such as body tremors caused by Parkinson's disease) easily ignored by the user. Device manufacturers and service providers face significant challenges to determine movement disorder via network services.

### SOME EXAMPLE EMBODIMENTS

Therefore, there is a need for an approach for determining potential movement disorder using sensor data.

According to one embodiment, a method comprises processing and/or facilitating a processing of one or more sequences of images to identify one or more reference objects, the one or more sequences of images captured via a device physically attached to a user. The method also comprises determining movement information of the one or more reference objects within the one or more sequences of images, wherein the movement information is at least substantially attributable to one or more physical movements of the user. The method further comprises processing and/or facilitating a processing of the movement information to cause, at least in part, a determination of one or more potential movement disorders associated with the user.

According to another embodiment, an apparatus comprises at least one processor, and at least one memory including computer program code, the at least one memory and the computer program code configured to, with the at least one processor, cause, at least in part, the apparatus to process and/or facilitate a processing of one or more sequences of images to identify one or more reference objects, the one or more sequences of images captured via a device physically attached to a user. The apparatus is also caused to determine movement information of the one or more reference objects within the one or more sequences of images, wherein the movement information is at least substantially attributable to one or more physical movements of the user. The apparatus is further caused to process and/or facilitate a processing of the movement information to cause, at least in part, a determination of one or more potential movement disorders associated with the user.

According to another embodiment, a computer-readable storage medium carries one or more sequences of one or more instructions which, when executed by one or more processors, cause, at least in part, an apparatus to process and/or facilitate a processing of one or more sequences of images to identify one or more reference objects, the one or more sequences of images captured via a device physically attached to a user. The apparatus is also caused to determine movement information of the one or more reference objects within the one or more sequences of images, wherein the movement information is at least substantially attributable to one or more physical movements of the user. The apparatus is further caused to process and/or facilitate a processing of the movement information to cause, at least in part, a determination of one or more potential movement disorders associated with the user.

According to another embodiment, an apparatus comprises means for processing and/or facilitating a processing of one or more sequences of images to identify one or more reference objects, the one or more sequences of images captured via a device physically attached to a user. The apparatus also comprises means for determining movement information of the one or more reference objects within the one or more sequences of images, wherein the movement information is at least substantially attributable to one or more physical movements of the user. The apparatus further comprises means for processing and/or facilitating a processing of the movement information to cause, at least in part, a determination of one or more potential movement disorders associated with the user.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining potential movement disorder using sensor data, according to one embodiment;

FIG. 2 is a diagram of the components of a health and wellness engine, according to one embodiment;

FIG. 3 is a flowchart of determining potential movement disorder using sensor data, according to one embodiment;

FIGS. 4A-4B are diagrams of a user device pointing at a marker utilized in the process of FIG. 3, according to various embodiments;

FIGS. 5A-5B are diagrams of user interfaces showing conceptual tremor in conjunction with stationary and moving markers, according to various embodiments;

FIGS. 6A-6D are diagrams of markers utilized in the process of FIG. 3, according to various embodiments;

FIGS. 7A-7G are diagrams of markers utilized for detecting motions, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for determining potential movement disorder using sensor data are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although various embodiments are described with respect to Parkinson's Disease, it is contemplated that the approach described herein may be used with other movement disorders such as akathisia, akinesia, athetosis, ataxia, ballismus, bradykinesia, cerebral palsy, chorea, dystonia, geniospasm, myoclonus, restless legs syndrome, spasms, stereotypic movement disorder, stereotypy, tardive dyskinesia, TIC disorders, Wilson's disease, etc.

As used herein, the term “healthcare” refers to the prevention, treatment, and management of illness and the preservation of mental and physical well-being through the services offered by the medical and allied health professions.

As used herein, the term “health care provider” refers to an individual or an institution that provides preventive, curative, promotional or rehabilitative health care services in a systematic way to individuals, families or communities. An individual health care provider may be a health care professional, an allied health professional, a community health worker, or another person trained and knowledgeable in medicine, nursing or other allied health professions, or public/community health. Institutions include hospitals, clinics, primary health care centers and other service delivery points.

As used herein, the term “health insurance provider” refers to a managed care organization that arranges a wide spectrum of healthcare services which commonly include hospital care, physicians' services and many other kinds of healthcare services with an emphasis on preventive care.

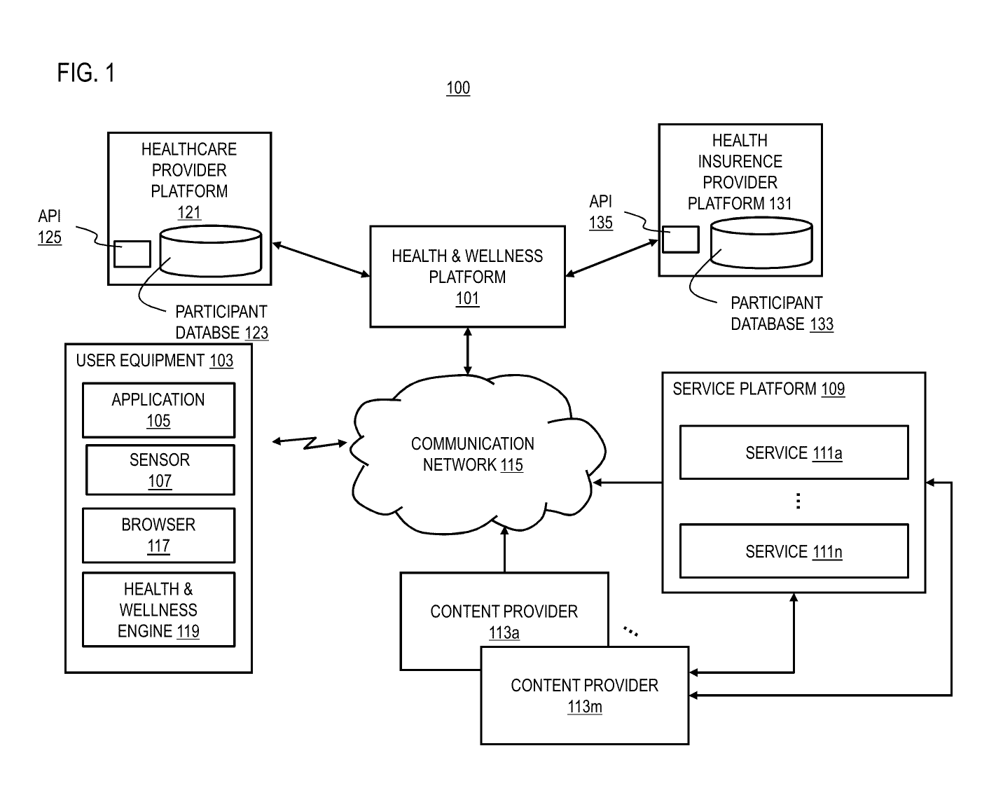

FIG. 1 is a diagram of a system capable of determining potential movement disorder using sensor data, according to one embodiment. As noted previously, service providers and device manufacturers may generate revenue or otherwise promote additional services, features, products, etc., by determining users' movement disorder via network services. By way of example, such movement disorders may be symptoms of Parkinson's disease.

Parkinson's Disease (PD) is a disorder of the brain's nerve cells that produce dopamine. In Parkinson's disease, dopamine producing cells break down, and the decreased dopamine level results in abnormal body movement. Parkinson's disease typically begins after the age of 50, and it progresses gradually over 10-15 years and causes increasing disability. The classic symptoms are shaking, stiff muscles and slow movement. People with advanced PD may also have a stooped posture and fixed facial look, speech impediments, loss of intellect, and balance problems. The tremor or shaking is usually the first visible symptom. Unlike other tremors, PD's resting tremor is worse when the subject is rested (without moving around).

Early detection of PD is hampered by the slow onset of the disease. Often by the time a diagnosis has been made the disease has already progressed. The detection and analysis of muscular movement indicate whether or not an individual is experiencing a motion-control problem. However, diagnosis is currently based on medical history and nervous system examination. There are no early-detection screening or laboratory tests to diagnose PD. Once the patient is thought to have PD, control medication may be given. When the medication alleviates the problem, diagnosis is confirmed.

PD tends to be a disease of the elderly and as such early detection suffers from confusion with other symptoms of the elderly. Current methods for detecting tremor range from single brain cell light scans to voice analysis. One approach of voice analysis is to detect distortions in the voice before full body tremors become noticeable via a doctor's visible examination of a patient. Another approach uses accelerometers fabric laying over a muscle group to detect minute micro-tremors of body muscles (e.g., throat muscles). However, these approaches require sophisticated equipments. There is a need of a new way for a user to interact with a simple device, such as a user device, to determine early symptoms of PD.

To address this problem, a system 100 of FIG. 1 introduces a health and wellness platform 101 with the capability to promote health and wellness and related information (e.g., disease information, preventative care, online health and wellness surveys and tests, health insurance offers, promotions, other materials, etc.). The information may be served in any formats, such as web pages, banners, in-application billboards, etc., to user devices.

As shown in FIG. 1, the system 100 comprises user equipment (UE) 103 having connectivity to the health and wellness platform 101, a service platform 109, and content providers 113a-113m via a communication network 115. Health is the level of functional and/or metabolic efficiency of a living being. In term of human beings, it refers to general conditions of a person in mind, body and spirit, usually meaning to be free from illness, injury or pain. Wellness refers to a healthy balance of the mind, body and spirit that results in an overall feeling of well-being. In the illustrated embodiment, the UE 103 includes one or more applications 105, one or more sensors 107, a browser 117, and a health and wellness engine 119.

The health and wellness engine 119 provides components that enable services to enhance health and wellness awareness, states, etc. In various areas (e.g., public health, personal health and wellness, preventative medicine, mental health, sport medicine, exercise machines, health club memberships, health food processors, natural fabric clothing, healthy cooking, etc.) via, for instance, the application 105 and/or the browser 117. In particular, the health and wellness engine 119 allows a user to interact with the UE 103 to determine early symptoms of movement disorder (e.g., PD).

In one embodiment, the application 105 is a client for at least one of the services 111a-111n of the service platform 109. In one embodiment, the application 105 is script delivered through the browser 117. In one embodiment, information and/or content files for promoting health and wellness can be specified by and/or obtained from the service platform 109, the services 111a-111n of the service platform 109, the content providers 113a-113m, and/or other components such as the health and wellness platform 101 or the health care provider platform 121 (discussed in more detail below).

In one embodiment, the sensors 107 determine, for instance, the local context of the UE 103 and any user thereof, such as user physiological state and/or conditions, medical conditions (e.g., diabetes, heart conditions, chronic wounds, injuries, etc.), a local time, geographic position from a positioning system, ambient temperature, pressures, sound and light, etc. By way of examples, various physiological parameters includes eye blink, head movement, facial expression, yawning, etc., while operating under a range of surrounding conditions. The sensor data can be use by the health and wellness engine 119 to monitor interactions with one or more reference objects shown on a user interface of the UE 103.

The UE 103 and/or the sensors 107 are used to determine the user's movements, by determining movements of the reference objects within the one or more sequences of images, wherein the movements of the reference objects are attributable to one or more physical movements of the user. In one embodiment, the UE 103 has a built-in accelerometer for detecting motions. The motion data extracted from the images is used for determining the movement disorder. In one embodiment, the sensors 107 collect motion signals by an accelerometer, a gyroscope, a compass, a GPS device, other motion sensors, or combinations thereof. The motion signals can be used independently or in conjunction with the images to determine movement disorder. Available sensor data such as location information, compass bearing, etc. Are stored as metadata, for example, in an image exchangeable image file format (EXIF).

By way of example, the UE 103 prompts the user to point the UE 103 at a stationary reference marker for a predetermined period of time (e.g., one minute), captures images of the marker before, during, and/or after the period, and analyzes the images of the marker to determine movement of the marks within the images that are attributable to the movement of the user.

In one embodiment, the system 100 continues to track and respond to subsequent user interactions with the presentation of a moving mark on the UE 103. For example, the system 100 may navigate or otherwise direct the user to continue pointing at the moving marker. In one embodiment, any of the information about the user movements and interactions with the marker can be recorded and analyzed.

In one embodiment, the health and wellness engine 119 compares captured images and detects motion by detecting changes between pixels in the captured images. The health and wellness engine 119 may compare all pixels in the images, or pixels of one or more image regions, or sample representative pixels. The health and wellness engine 119 may compare pixel values between successive image frames and may produce a difference value for each compared pixel. In the absence of motion in the images, the pixels should change very little. The health and wellness engine 119 then compares the values to a threshold or thresholds in order to detect motion in the images. By way of example, a designated object between image frames is a crosshair marker at or near the center of the image.

Beside a crosshair marker, a sampling pattern/marker of other sizes, format, etc. may designate predetermined pixels to be sampled for the motion detection process specified for different types of movement disorders and relevant diseases. The sampling pattern may be used for an entire image comparison, a designated object comparison, a regions comparison, etc. By using the sampling pattern, the health and wellness engine 119 may sample only designated pixels. This reduces processing time and processing requirements while still providing a reliable motion determination.

The imaging interval used by the health and wellness engine 119 to take images may also be specified for different types of movement disorders and relevant diseases. In another embodiment, the imaging interval is set by a user or a healthcare provider. The imaging interval may be chosen to accommodate a particular image capturing environment. The smaller the imaging interval is, the finer resolution the motion detection is yet consuming more processing resources.

The one or more motion thresholds and/or criteria associated with the one or more potential movement disorders are predetermined based upon clinical experimental data specified for different types of movement disorders and relevant diseases. If the detected amount of pixel change is greater than a corresponding motion threshold and/or criteria, the health and wellness engine 119 determines that there is movement occurring in the most recently captured image. Conversely, if the detected amount of pixel change is less than or equal to the motion threshold, then the health and wellness engine 119 may determine that the level of motion is ignorable.

The health and wellness engine 119 discriminates Parkinson Disease tremor from normal physiologic tremor by examining their respective median frequency of oscillation, spectral power distribution, and specific range power distribution, in view of some reference tremor patterns.

It should be understood that one or more motion thresholds and/or criteria may be used to compare multiple image regions. In one embodiment, a single threshold may cover all regions. In another embodiment, each region may include a corresponding threshold and/or criterion. In yet another embodiment, some regions may have individual thresholds/criteria and some regions may share a common threshold/criterion.

In one embodiment, the health and wellness engine 119 presents a movement report with respect to the UE 103's location, user profile information (e.g., health history, demographics, preferences), and other context information (e.g., activity, diseases, time, etc.). The user can be presented with related health and wellness information and/or offers in the form of in-application billboards. In one embodiment, the health and wellness engine 119 exploits context-aware interfaces to affect, for instance, how, when, what, etc. The information and/or offers are presented based, at least in part, on the context of user situations, needs, friend network recommendations, location search results, click history, etc.

By way of example, the health and wellness engine 119 detects brief, involuntary twitching of a hand muscle at different occasions. The jerks may occur alone and/or in sequence, in a pattern and/or without pattern, infrequently and/or many times each minute. Since the jerks may be signs of a wide variety of nervous system disorders, such as multiple sclerosis, Parkinson's disease, Alzheimer's disease, subacute sclerosing panencephalitis and Creutzfeldt-Jakob disease (CJD), serotonin toxicity, and some forms of epilepsy, the health and wellness engine 119 may survey the user family and/or personal disease history, and/or retrieve the information form one more databases, to determine a possible diagnosis. Based upon the diagnosis, the health and wellness engine 119 presents relevant information (e.g., symptoms, disease management, treatment, medication, etc.) and offers (e.g., healthcare providers, health insurance plan, over-the-counter medication, alternative medicine, healthy food choices, etc.) to the user.

In one embodiment, the degrees and forms of presentation interactivity have are limited based on the types and sources of sensor data available to the UE 103 presenting the health and wellness information and/or offers. In addition, the presentation interactivity may be customized for particular individuals.

The sensors 107 can be independent devices or incorporated into the UE 103. The sensors 107 may include an accelerometer, a gyroscope, a compass, a GPS device, microphones, touch screens, light sensors, or combinations thereof. The sensors 107 can be a head/ear phone, a wrist device, a pointing device, or a head mounted display. By way of example, the user wears a sensor that is in a headphone and provides directional haptics feedback to determine the position of the ears in a space and relevant movements of the ears/head. The user can wear a head mounted display with sensors to determine the position, the orientation and movement of the user's head. The user can wear a device around a belt, a wrist, a knee, an angle, etc., to determine the position, the orientation and movement of the user's hip, hand, leg, foot, etc. The device gives an indication of the direction and movement of an object of interest in a 3D space.

The health and wellness engine 119 enables the use of the health and wellness platform 101 (e.g., via an API) and sensor data to present health and wellness information and/or offers, as well as determination of movement disorder in the application 105. By way of example, the application 105 may present the information and/or offers in a portion of a graphical user interface (GUI) associated with the application 105. Further, the health and wellness platform 101 may control health and wellness information and/or offers provided to and/or presented by the applications 105 via the health and wellness engine 119.

As the health and wellness platform 101 is used to present the information and/or offers, sensor data can be collected by the sensors 107 and then used by the health and wellness engine 119 to present additional health and wellness information and/or offers. In one embodiment, health and wellness information and/or offers to be displayed to users of devices can be retrieved from a healthcare server, stored in a cache of the device, and presented to the user. The health and wellness engine 119 can retrieve health and wellness information and/or offers from the cache to present within one or more applications. In certain embodiments, a health and wellness engine is a program and/or hardware resident on a device that can retrieve health and wellness information and/or offers from the healthcare server and control presentation of the health and wellness information and/or offers. The health and wellness engine 119 can fetch health and wellness information and/or offers from a healthcare server or platform via an Application Programming Interface (API) to store in the cache for presentation via, for instance, the applications 105. Further, the health and wellness engine 119 can provide an API for applications running the health and wellness engine to request health and wellness information and/or offers to present.

As used herein, the user refers to an entity to which the health and wellness information and/or offers and the determination of movement disorder are presented (e.g., via the UE 103 associated with the user). The user can respond to the health and wellness information and/or offers and the determination of movement disorder, which, in turn, can trigger other related health and wellness information and/or offers based on the user's continued interaction. As previously described, the determination of movement disorder and the user interactions can be tracked for reporting to healthcare providers, health insurance providers, health related services/products merchants, and other entities involved in the healthcare industry, public health, etc. Health related services may include physical and/or physiological therapies, body massages, etc. Health related products may include protein bars, organic food, books on health and wellness, etc.

In one embodiment, the healthcare activities of healthcare providers is facilitated by the health care provider platform 121, which includes, for instance, one or more portals, products, services, participant databases 123, application programming interfaces (APIs) 125, etc. To support connectivity or access by healthcare providers and affiliated merchants, advertisers, and the like. By way of example, the available means include applications (e.g., an application 105 executing at the UE 103), sensors (e.g., a sensor 107 at the UE 103), services (e.g., a service platform 109, one or more services 111a-111n of the service platform 109), content providers 113a-113m, and other similar entities. In one embodiment, the healthcare activities of the health insurance providers are facilitated by the health insurance provider platform 131 which includes, for instance, one or more portals, participant databases 133, application programming interfaces (APIs) 135, etc. To support connectivity or access by health insurance providers, content providers, and the like.

More specifically, in one embodiment, the system 100 exposes relevant interfaces (e.g., application programming interfaces (APIs)) to healthcare providers, health insurance providers, merchants/advertisers, etc. To target users for presentation of one or more health and wellness information and/or offers. In one embodiment, the system 100 targets users for health and wellness information and/or offers based, at least in part, on location-based services used by the users. In one embodiment, the corresponding health and wellness information and/or offers and the determination of movement disorder may be served based on a contractual relationship with the providers matching the result.

In the illustrated embodiment, a health insurance provider platform 131 is included for servicing existing subscribers, and promoting health insurance products, including applications, etc. In one embodiment, the health insurance provider platform 131 maintains a participant database 133. In one embodiment, the products/services may be provided through the service platform 109, the services 111a-111m, and/or the content providers 113a-113m and are thus associated with a health insurance provider. In one embodiment, the health insurance provider platform 131 also provides access to analytical reports generated by the health and wellness platform 101. In one embodiment, access to the information on the participant database 133 is controlled to only privileged services (e.g., the health and wellness platform 101 and other authorized users). In some embodiments, access is obtained through an API 135.

As shown, the system 100 includes a health care provider platform 121 for providing access to the functions of the health and wellness platform 101 to health care providers, merchants and advertisers. In one embodiment, the health care provider platform 121 maintains a participant database 123 for storing data and criteria for patients, healthcare campaigns, and other related information. In one embodiment, the content information (e.g., media files, graphics, etc.) for the health and wellness information and/or offers may be obtained from or provided directly by the service platform 109, the services 111a-111n, and/or the content providers 113a-113m. In one embodiment, the health care provider platform 121 also provides access to analytical reports generated by the health and wellness platform 101 to other entities. In one embodiment, access to the information on the participant database 125 is controlled to only privileged services (e.g., the health and wellness engine 119). In some embodiments, access is obtained through an API 125.

In one embodiment, the health care provider platform 121 may be used to update the health and wellness information and/or offers (e.g., specify new health and wellness information and/or offers, target demographics or users, etc.). The reports may include information as to what the healthcare goal of the user is (e.g., recovery, the target weight, strength, etc.), time period to meet the target, groups of demographics and/or confidence levels associated with those groups, a target rate for meeting the goal over the time period, etc. Moreover, the health care provider platform 121 may additionally be utilized to enter input to manually adjust target user criteria or parameters (e.g., based on progress of the healthcare goals).

More specifically, the health and wellness platform 101 feeds the health and wellness engine 119 with health and wellness information and/or offers from any number of sources (e.g., the service platform 109, services 111, the health care provider platform 121, the health insurance provider platform 131, online stores, third party networks, etc.). In one embodiment, the health and wellness platform 101 may route health and wellness information and/or offers based, at least in part, on context information (e.g., location, time, activity, etc.). In this way, the health and wellness platform 101 can, for instance, apply country-by-country or region-by-region rules and/or polices for presenting health and wellness information and/or offers.

In one embodiment, the health and wellness platform 101 can interact with diagnosis-related hospital/doctor's office visit for tracking the accuracy of the diagnosis for self-correction purposes. In addition, or alternatively, the health and wellness platform 101 can report the determination of movement disorder and/or final diagnosis to end users, healthcare providers, health insurance providers, merchants, advertisers, and/or other users of the health and wellness platform 101, with the user's permission. In one embodiment, the health and wellness platform 101 can also collect context information, profile information, usage information, and the like from users to facilitate, for example, targeted healthcare, personalization of health and wellness information and/or offers, enriching of health and wellness information and/or offers, etc.

In one embodiment, the health and wellness platform 101 can generate reports providing metrics associated with health and wellness information and/or offers presentation, user interactions with respect to the movement disorders, diagnosis effectiveness, yield, and other information generated by, for instance, the other modules of the health and wellness platform 101.

In one embodiment, health care providers access the functions of the health and wellness platform 101 from the health care provider platform 121 through the health care provider API 125. For example, the health care provider platform 121 can provide a portal (e.g., a web portal or other client) for submitting healthcare requests, selecting healthcare means, obtaining reports, receiving healthcare recommendations, and/or otherwise managing their information and/or their healthcare campaigns. In addition, or alternatively, it is contemplated that the health and wellness platform 101 can incorporate all or a portion of the functions of the health care provider platform 121 for directly interacting with health care providers.

Similarly, in one embodiment, health insurance providers access the functions of the health and wellness platform 101 from the health insurance provider platform 131 via the health insurance provider API 135. In this example, the health insurance provider platform 131 can provide a portal for health insurance providers to register products or services for presenting products/services, retrieving information for presentation to users, generating reports, personalizing information based on context, and/or any other functions of the health and wellness platform 101. In addition, or alternatively, it is contemplated that the health and wellness platform 101 can incorporate all or a portion of the functions of the health insurance provider platform 131 for directly interacting with health insurance providers.

By way of example, the communication network 115 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 103 is any type of mobile terminal, fixed terminal, or portable terminal including a mobile handset, station, unit, device, multimedia computer, multimedia tablet, Internet node, communicator, desktop computer, laptop computer, Personal Digital Assistants (PDAs), audio/video player, digital camera/camcorder, positioning device, television receiver, radio broadcast receiver, electronic book device, game device, or any combination thereof. It is also contemplated that the UE 103 can support any type of interface to the user (such as “wearable” circuitry, etc.).

By way of example, the UE 103 and the health and wellness platform 101 communicate with each other and other components of the communication network 115 using well known, new or still developing protocols. In this context, a protocol includes a set of rules defining how the network nodes within the communication network 115 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the UE 103 (e.g., the health and wellness engine 119), the health care provider platform 121, and/or the health insurance provider platform 131, interact with the health and wellness platform 101 according to a client-server model. According to the client-server model, a client process sends a message including a request to a server process, and the server process responds by providing a service (e.g., movement disorder diagnosis processing, health and wellness information and/or offers, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

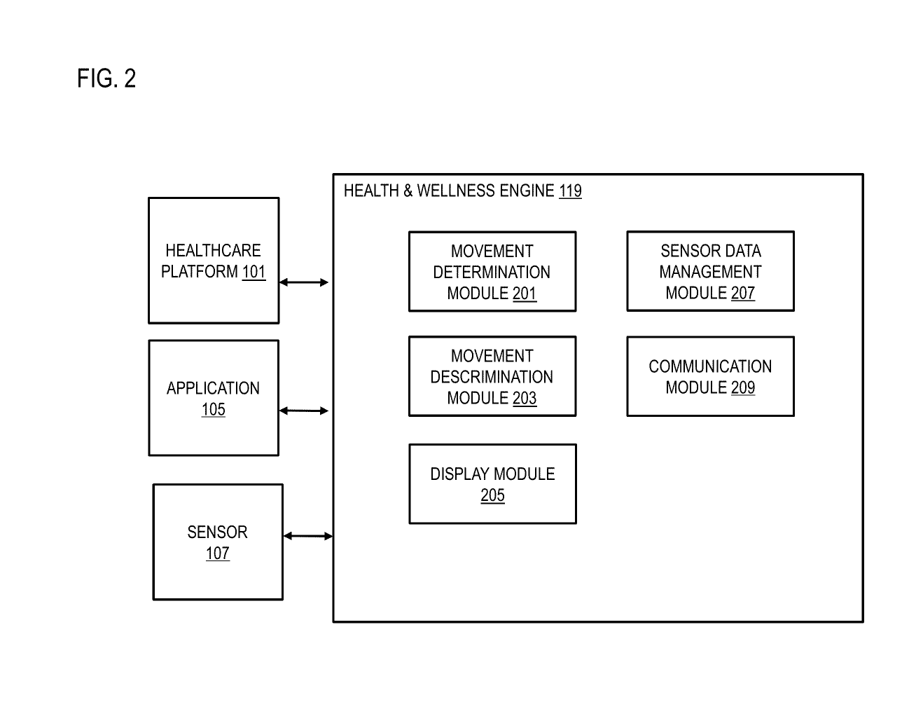

FIG. 2 is a diagram of the components of a health and wellness engine 119 according to one embodiment. By way of example, the health and wellness engine 119 includes one or more components for determining potential movement disorder using sensor data. It is contemplated that the functions of these components may be combined in one or more components or performed by other components of equivalent functionality. In this embodiment, the health and wellness engine 119 includes a movement determination module 201, a movement discrimination module 203, a display module 205, a sensor data management module 207, and a communication module 209.

In one embodiment, the movement determination module 201 determines whether a user has tremor that moved the UE 103 in a way detectable by the sensors 107 of the UE 103. By way of example, the movement determination module 201 uses a video or still image camera for determining movement disorder of a user holding the camera. In one embodiment, the movement disorder is determined via detecting the tremor of the user. Tremor is the most common form of involuntary movement. Tremor is an involuntary, rhythmic oscillatory movement of a part or parts of the body, resulting from alternating or irregularly synchronous contractions of antagonist muscles.

The user activates the camera (which may be built in the UE 103), holds the camera in one hand and points it to a non-moving target (e.g., a surface or wall containing one or more markers). A marker can be any artifact (e.g., crosshairs) visible on the camera and to be tracked from frame to frame. The movement determination module 201 then activates an onboard software application to sample the camera's output stream.

The movement determination module 201 detects the movement of these markers between frames via intra-frame analysis of successive frames in the output stream, such as examining the frames for marker displacement. The changes in position of the markers are caused by the user shaking/moving the camera. In one embodiment, the movement determination module 201 applies a mixture model change detection algorithm, such as Gaussian mixture model (GMM) change detection algorithm, to remove the non-changing areas. A mixture model is a probabilistic model for representing the presence of sub-populations within an overall population, without requiring that an observed data-set should identify the sub-population to which an individual observation belongs. Therefore, a table of time based-vectors of camera motions is produced. When the marker is not moving, any detected movement is resulted from the camera moving.

The movement determination module 201 then applies an algorithm, e.g., a hidden Markov model (HMM) algorithm, to detect and recognize minute changes in position, lighting, texture, edges and coloring of markers appearing in sequences of frames. HMM is a probabilistic model used to align and analyze sequence datasets by generalization from a sequence profile.

Tremors may result from normal (physiologic) or pathologic processes and may be characterized by their etiology or phenomenology (e.g., activation state, frequency, amplitude, waveform). Rest tremor occurs when muscle is not voluntarily activated, whereas action tremor is present with voluntary contraction of muscle. Tremor may be further delineated by anatomic distribution (e.g., the head, including the chin, face, tongue, or palate, the upper or lower extremities, the voice or trunk); frequency; and coexistent neurologic conditions, use of tremorogenic medications, or other causative states.

In one embodiment, the movement discrimination module 203 uses partial least squares (PLS) regression to weight tremor data parameters (such as frequency, direction, time, etc.) based on motion discrimination between different types of tremor (e.g., normal physiologic tremor, PD tremor, etc.).

The PLS method is popular in industries to collect correlated data on many predictor variables (e.g., x-variables). For example, multivariate calibration in analytical chemistry, spectroscopy in chemometrics, and quantitative structure activity relationships (QSAR) in drug design. PLS regression models the relationship between two or more explanatory variables and a response variable by fitting a “least squares” equation to observed data if: the number of x-variables is relatively high compared with the number of observations, the x-variables are correlated, and there is more than one response variable (e.g., y-variable) and these variables are correlated.

The PLS method extracts orthogonal linear combinations of predictors, known as factors, from the predictor data that explain variance in both the predictor variables and the response variable(s). In general, a PLS analysis consists of the following stages:
1. Calculate a PLS model using a high number of factors (more than is likely to be required);
2. Determine the number of factors to include in a fitted model by either: analyzing information calculated during the process of extracting factors, or calculating a prediction accuracy estimate based on, e.g., cross-validation;
3. Fit the model with the determined number of factors by calculating parameter estimates of the linear regression; and
4. Given a set of predictors and responses used to fit a PLS model, and a suitable number of factors.

The movement discrimination module 203 processes the timeline by fast Fourier transform (FFT) to produce a power spectrum to discover which frequencies and their amplitudes were present in the motion and what is their relationship. The movement discrimination module 203 measures and compares both acceleration and velocity of normal physiologic tremor and Parkinson Disease tremor. By way of example, PD tremor can be differentiated from normal physiologic tremor by amplitude fluctuation, frequency spectrum harmonics and proportional power in 4 to 6 Hz. As PD is recognized by the characteristic PD tremor, detection of this tremor aids in early diagnosis of this disease.

In another embodiment, the movement discrimination module 203 retrieves reference tremor patterns detected via other mechanisms, such as accelerometric studies, short-term or long-term electromyography (EMG), graphic digitizing tables for the measurement of tremor during drawing and writing, electroencephalography (EEG), etc. These mechanisms measure tremor magnitudes and frequencies to generate retrieves reference tremor patterns. The reference tremor patterns depict frequencies, spectral power distribution, specific range power distribution, etc., unique for particular types of movement disorder. By way of example, a reference normal physiologic tremor pattern is detected on EMG ranging in 8-12 Hz. A normal physiologic tremor occurs in all contracting muscle groups, including hand muscles. Physiologic tremor may often be detected when the fingers are firmly outstretched with a piece of paper placed over the hands. Parkinsonian tremor is primarily resting tremor (e.g., greater than 4 Hz), and other forms of tremor (e.g., kinetic/postural tremor with similar or higher, non-harmonically related frequencies). Less commonly, isolated postural/kinetic tremors may be present at a frequency more than 1.5 Hz higher than the rest tremor rate.

A user profile may reside on the UE 103 or receivable from another network entity that communicates with the UE 103. The profile information may be considered by the movement discrimination module 203 to determine which reference tremor patterns to retrieve. The movement discrimination module 203 may retrieve the reference tremor patterns based on demographics include age, sex, race, disabilities, mobility, education, home ownership, employment status (e.g., employed, underemployed, unemployed, etc.), location (e.g., urban, suburban, rural, etc.), income level (e.g., middle-class, upper-class, upper-middle-class, poor, etc.), military status, family status, marriage status, vehicles owned, etc. A demographic target and/or demographic group can include one or more demographics and/or demographic ranges as parameters to be selected by the user, healthcare provider, health insurance provider, etc., to retrieve one or more reference tremor patterns.

The movement discrimination module 203 then maps the camera movement data to the patterns per frequency, by normalizing the amplitude of the camera movement data to fit the patterns. The movement discrimination module 203 identifies and discriminates PD tremor from different syndromic tremor classifications (e.g., normal physiologic tremor) for the particular user, and outputs the comparison results, e.g., whether the user tremor includes early PD tremor.

One set of consensus criteria describe syndromes based upon clinical observations of syndromic classifications including essential tremor, physiologic/normal tremor, enhanced physiologic tremor, indeterminate tremor syndrome, primary orthostatic tremor, dystonic tremor, task- and position-specific tremors, Parkinsonian tremor syndromes, Cerebellar tremor syndromes, Holmes tremor, palatal tremors, neuropathic tremor syndrome, drug-induced and toxic tremor syndromes, psychogenic tremor, and myorhythmia.

In yet another embodiment, the movement discrimination module 203 retrieves reference tremor pattern parameters (e.g., signature frequencies, time of the day, etc.) discovered via other mechanisms, such as EMG, EEG, etc., and compares signature frequencies (e.g., a median frequency of oscillation). Both acceleration and velocity measurements taken near or at signature frequencies are made and compared.

Electromyography (EMG) uses an electromyograph for evaluating and recording the electrical activity produced by skeletal muscles. An electromyograph detects the electrical potential generated by muscle cells when these cells are electrically or neurologically activated. The signals can be analyzed to detect medical abnormalities, activation level, recruitment order or to analyze the biomechanics of human or animal movement. The electrical source is the muscle membrane potential of about −90 mV. Measured EMG potentials range between 50 μV and 20-30 mV, depending on the tested muscle. Typical repetition rate of muscle motor unit firing is 7-20 Hz, depending on the size of the muscle, previous axonal damage, etc. Damage to motor units can be expected at ranges between 450 and 780 mV.

Electroencephalography (EEG) is the recording of electrical activity along the scalp. EEG measures voltage fluctuations resulting from ionic current flows within the neurons of the brain. In clinical contexts, EEG refers to the recording of the brain's spontaneous electrical activity over a short period of time, usually 20-40 minutes, as recorded from multiple electrodes placed on the scalp. In neurology, the main diagnostic application of EEG is in the case of epilepsy, as epileptic activity can create clear abnormalities on a standard EEG study. Glossokinetic artifacts are caused by the potential difference between the base and the tip of the tongue. Minor tongue movements can contaminate the EEG, especially in parkinsonian and tremor disorders.

In other embodiments, the UE 103 has a compass or various position and orientation measuring sensors to measure an exact direction and angle where the UE 103 is turned and/or tilted, while pointing the UE 103 at a marker moving according to a predetermined route. The movement discrimination module 203 tracks the movement of the UE 103 and measures errors resulting from tremor during performance of pointing.

In another embodiment, the movement discrimination module 203 retrieves gyroscope data that sense hand, trunk, and/or limb rotation rate. The movement discrimination module 203 tracks the movement of the UE 103 manual tasks (e.g., cutting a piece of paper to a particular shape) and measures errors resulting from tremor during performance of manual tasks.

In yet another embodiment, the movement discrimination module 203 retrieves mechanically and optically collected digital coordinates of the camera movement. By way of example, light-emitting or infrared diodes are attached to the user to provide the sensor data collected when the user performs a series of movements including, but not limited to, resting, sitting, standing walking, etc., based upon a predetermined route. The movement discrimination module 203 tracks the user physical movement and measures errors resulting from tremor during performance of physical movement. By way of example, the UE 103 uses GPS, a cell ID and other techniques to measure the UE's 103 location.

Based on the determination made by the movement determination module 201 and the movement discrimination module 203, the display module 205 determines what images and perspective views of the determined tremor to display at the UE 103. As mentioned, the UE 103 may also present health and wellness information and/or offers to the user. The display module 205 further determines what health and wellness information and/or offers to display at the UE 103 based upon the outputs of the movement discrimination module 203. By way of example, the display module 205 displays a list of preferable healthcare providers specialized in PD if the user appears to have movement disorders related to PD.

In patients with tremor, diagnostic evaluation by a healthcare provider is critical in order to confirm that the user actually has PD. The evaluation begins with a thorough medical and historical evaluation to determine presence of a positive family history, age of onset, anatomical distribution, type, and severity of tremor, presence of abrupt tremor onset or concomitant neurologic disease that may suggest an alternative diagnosis, administration of pharmaceutical agents or exposure to toxins that may induce tremor, effect of ethanol on tremor symptoms.

The sensor data management module 207 determines what sensor data is to be used for determining the camera movement. The sensor data management module 207 can directly determine context information via, for instance, one or more sensors or sources of context information available at the UE 103.

In one embodiment, the UE 103 has a microphone for detecting sound (e.g., voice, music, noise, etc). The sound data is used by the sensor data management module 207 to measure an exact direction and angle where the UE 103 is turned and/or tilted, thereby determine the rotation of the UE 103.

In one embodiment, the UE 103 has a tilt sensor, a GPS receiver, a proximity sensor, a compass, an advanced gravity sensor, or a combination thereof. The position data is used by the sensor data management module 207 to tracks the user physical movement and measures errors resulting from tremor during performance of physical movement.

In one embodiment, the UE 103 has an ambient light sensor. The ambient light data is used by the sensor data management module 207 to measure an exact direction and angle where the UE 103 is turned and/or tilted, thereby determine the rotation of the UE 103.

In one embodiment, the UE 103 has a skin conductance sensor. The skin conductance data reflects emotional and/or physiological arousal of the user, and is used by the sensor data management module 207 to associate the determination with a user state, for example, exercising, etc. The user state can be used by the movement discrimination module 203 to retrieve relevant reference tremor patterns, such as the user's historical pattern of the same state, etc.

In one embodiment, the UE 103 has a temperature sensor. The temperature data is used by the sensor data management module 207 to associate the determination to a test environment state, for example, hot, etc. The test environment state can be used by the movement discrimination module 203 to retrieve relevant reference tremor patterns, such as relevant reference patterns took in the same test environment, etc.

In some cases, the UE 103 has a computer vision for object recognition (e.g., a table) and for improving the accuracy of the health and wellness engine 119. There are state of the art computer vision algorithms which include feature descriptor approaches for assigning scale and rotation invariant descriptors to an object. For example, scale-invariant feature transform (SIFT) is an algorithm in computer vision to detect and describe local features in images. Speeded up robust features (SURF) is a robust image detector and descriptor used in computer vision tasks like object recognition or 3D reconstruction. In another embodiment, fast “optical flow” algorithms can be deployed to determine which direction the UE 103 appears to be rotating in order to confirm the sensor reported rotations.

The movement discrimination module 203 retrieves information (e.g., reference tremor patterns, health and wellness information and/or offers, etc.) by way of the communication module 209. The communication module 209 receives health and wellness information and/or offers from, for instance, the health and wellness platform 101 or other networks available over the communication network 115. The health and wellness information and/or offers (e.g., patent records, information related to how and when to take medication, etc.) can then be stored or cached in the health and wellness engine 119. In one embodiment, the communication module 209 can retrieve interaction information from one or more applications (e.g., application 105, browser 117, etc.) executing at the UE 103.

In other words, the communication module 209 serves as the entry and exit points for receiving health and wellness information and/or offers and then placing and/or handing off the information and/or offers to the means for presenting (e.g., the application 105, the browser 117) at the UE 103. In one embodiment, the communication module 209 can also relay context and/or profile information to the health and wellness platform 101 to facilitate enriching the health and wellness information and/or offers with personalized or other custom information. In this way, the health and wellness information and/or offers can be more specifically targeted and/or tailored to individual characteristics and/or preferences of a user. The profile information of the user may include a user ID, age, sex, health record, disease history, preference data of the user, such as likes or dislikes food, clothing, housing, vehicles, learning, entertainments, etc. Any processing that is done by the UE 103 may be output by the communication module 209 to the health and wellness platform 101 for data-mining.

As shown, the communication module 209 has connectivity to components external to the health and wellness engine 119; for example, the health and wellness platform 101, the application 105, the browser 117, and/or other like components. In one embodiment, the communication module 209 exposes its interface via standard APIs (e.g., Qt, Web Runtime (WRT), Java, etc.).

In one embodiment, the health and wellness engine 119 collects, for instance, user interactions and/or responses to a presentation of the health and wellness information and/or offers served through the health and wellness engine 119. In one embodiment, the health and wellness engine 119 can also monitor context changes, profile information, etc. Associated with the UE 103 or a user associated with the UE 103 to, for example, facilitate the customization and/or personalization of health and wellness information and/or offers, reference tremor patterns, etc.

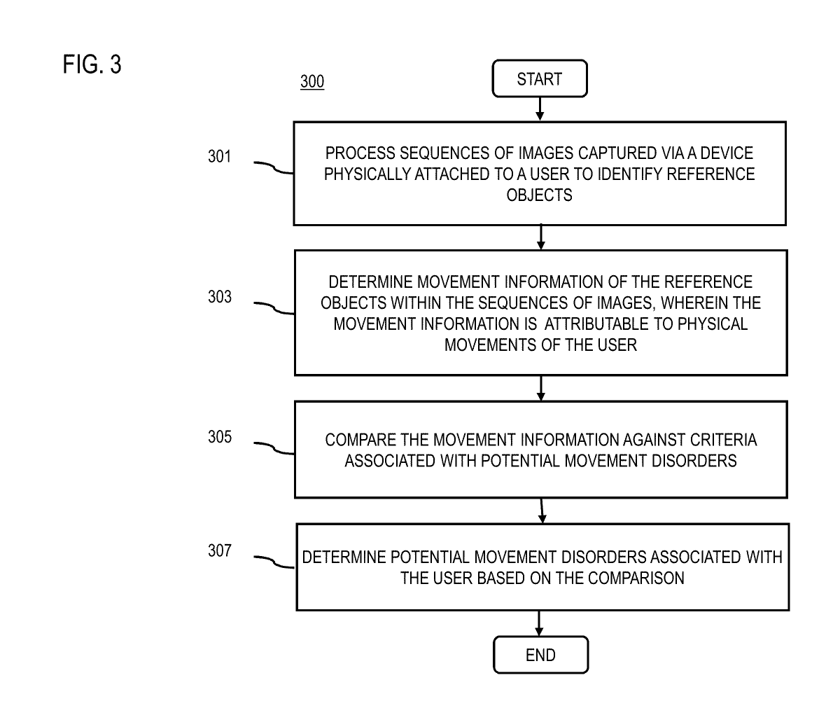

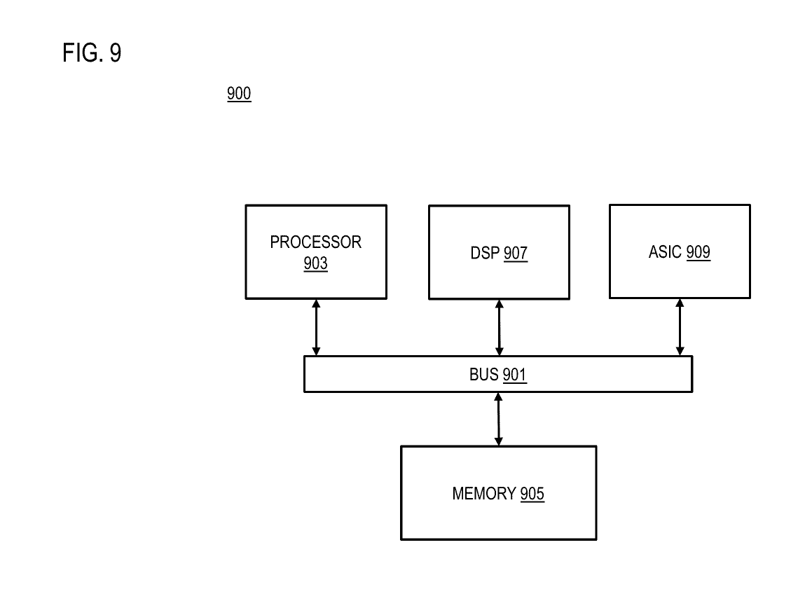

FIG. 3 is a flowchart of determining potential movement disorder using sensor data, according to one embodiment. In one embodiment, the health and wellness engine 119 performs the process 300 and is implemented in, for instance, a chip set including a processor and a memory as shown FIG. 9. In addition, or alternatively, all or a portion of the process 300 can be performed by the health and wellness platform 101, the health care provider platform 121, the health insurance provider platform 131, or a combination thereof.

In step 301, the health and wellness engine 119 processes and/or facilitates a processing of one or more sequences of images to identify one or more reference objects, the one or more sequences of images captured via a device (e.g., a built-in camera of the UE 103) physically attached to a user. The device is physically attached to the user by having the user hold the device, wear the device on wrist, etc.

The one or more reference objects include, at least in part, one or more stationary reference objects (e.g., a crosshair marker on a wall), one or more moving reference objects with a known pattern of movement (e.g., a marker moving in a wave-shaped line), or a combination thereof. The one or more reference objects have one or more predetermined shapes (that are easier to for the user to aim, such as crosshairs), one or more predetermined configurations (that are easier to detect movement, such as a target shape), or a combination thereof. As explained later, the health and wellness engine 119 can isolate the actual movement of the moving marker from the movement contributed by hand and other factors.

In step 303, the health and wellness engine 119 determines movement information of the one or more reference objects within the one or more sequences of images, wherein the movement information is at least substantially attributable to one or more physical movements of the user (e.g., normal physiologic tremor, PD tremor, etc.). The movement information includes, at least in part, one or more acceleration measurements, one or more velocity measurements, or a combination thereof of the one or more reference objects (e.g., markers) with respect to any one or more axis of movement.

The health and wellness engine 119 processes and/or facilitates a processing of the movement information based, at least in part, on the at least one frequency of oscillation (e.g., of tremor), at least one spectral power distribution (e.g., of tremor), at least one specific range power distribution (e.g., of tremor), or a combination thereof. By way of example, a reference normal physiologic tremor pattern is detected on EMG ranging in 8-12 Hz. Parkinsonian resting tremor is greater than 4 Hz, and kinetic/postural tremor may be present at a frequency more than 1.5 Hz higher than the rest tremor rate.

In step 305, the health and wellness engine 119 causes, at least in part, a comparison of the movement information against one or more criteria associated with the one or more potential movement disorders (e.g., reference tremor patterns based on a selected demographic target and/or demographic group by the user, healthcare provider, health insurance provider, etc.). In step 307, the health and wellness engine 119 cause, at least in part, a determination of the or more potential movement disorders associated with the user based, at least in part, on the comparison.

The health and wellness engine 119 determines that the user has no movement disorder, if there is no reference tremor pattern of movement disorder can be mapped to the user's movement/tremor data. Otherwise, the health and wellness engine 119 determines that the user may have movement disorder, and suggests the user to see a doctor to verify the determination of movement disorder. The possibility of movement disorder can be determined based upon the degree of similarity between the user's movement data and the reference tremor pattern of movement disorder. The similarity may be report as a percentage of likelihood that the user has a corresponding kind of movement disorder.

In one embodiment, the health and wellness engine 119 determines previously stored movement information associated with the user. The determination of the one or more potential movement disorders is further based, at least in part, on the previously stored movement information. By way of example, Parkinson's disease takes on five different stages. The time spent at each stage of the disease varies, and the skipping of stages is not uncommon. Typically these symptoms will include the presence of tremors or experiencing shaking in one of the limbs. The health and wellness engine 119 compares the user's older tremor data to determine if any movement disorder is developing or progressing into different stages.

In another embodiment, the health and wellness engine 119 causes, at least in part, a capture of the one or more sequences of images following a completion of one or more physical activities (e.g., walking, running, jumping, etc.) by the user. The health and wellness engine 119 determines the one or more potential movement disorders further based, at least in part, on the images captured before, during, or after the activities. Some types the movement disorder may be better observed before, during, or after the activities.

In addition to a condition that the user is in a particular place, the health and wellness engine 119 uses other sensor data to determines other conditions, e.g., a speed, a direction of movement, a type of movement: jumping, running, etc. For example, the health and wellness engine 119 determines the running speed of the user by an accelerometer of the UE 103. In another example, when the user is required to jump in a particular place, the jumping location is also determined by the accelerometer. In yet another example, when the user is required to spin, the spinning is measured with a gyroscope.

The sensors may include an electronic compass that gives heading information and reflects whether the UE 103 is held horizontally or vertically, a 3-axis accelerometer that gives the orientation of the UE 103 in three axes (pitch, roll and yaw) and determines types of user conscious body motions (such as running, jumping etc.), since these actions cause specific periodic accelerations), or a gyroscope that reads an angular velocity of rotation to capture quick head rotations.

In one embodiment, the health and wellness engine 119 determines other movement information (e.g., normal physiologic tremor) associated with the one or more physical activities, a control state of the user (e.g., sitting, standing on one leg, etc.), or a combination thereof. In one embodiment, the health and wellness engine 119 determines to normalize (e.g., removing normal physiologic tremor associated with the one or more physical activities) for the other movement information in the determination of the movement information (e.g., movement disorder).

In one embodiment, the health and wellness engine 119 causes, at least in part, a presentation of the movement information, potential movement disorders, at a device (e.g., the UE 103, a device hosting API 125 of the health care provider platform 121, a device hosting API 135 of the health insurance provider platform 131, etc.). The presentation may include historical data, data of one or more other users, etc. In one embodiment, the presentation includes, previous and/or current the movement information, potential movement disorders, or a combination thereof, of the same user, for the user, healthcare providers, etc. to compare past and current states of the user.

The health and wellness engine 119 then causes, at least in part, an initiation of the one or more actions based, at least in part, on the input, the user interaction, or a combination thereof. The one or more actions include, at least in part, an expansion of the perspective display (e.g., a bigger size and/or representation), another presentation of additional information related to the one or more determination results (e.g., more detailed description about PD, etc.), an establishment of a communication session with at least one entity associated with the one or more determination results (e.g., using Twitter®, instant messaging, etc. to order the items), or a combination thereof.

For example, a doctor appointment is activated and auto-completed when a user selects a physician displayed on the screen of the UE 103 via a built-in microphone and a voice recognition application. The microphone receives user's voice input and the voice recognition application converts the voice into content data for the UE 103 to transmit directly to a doctor's office via a near field communication channel (e.g., radio frequency signals, Bluetooth, etc.), or via the communication network 115 and the health and wellness platform 101. The server of the doctor's office may be connected with the health care provider platform 121, the health insurance provider platform 131, or a combination thereof.

In another embodiment, the health and wellness engine 119 causes, at least in part, tracking of user interaction information in response to the presentation of the health and wellness information and/or offers. In this way, the health and wellness engine 119 provides for continuous interaction with the UE 103 to provide for presentation and tracking of related health and wellness information and/or offers and to tailor the healthcare experience to the continuing actions taken by the user.

It is contemplated that the one or more results, the at least one merchant, the health and wellness information and/or offers, the user interaction, or a combination thereof relate to online commerce, offline commerce, or a combination thereof. More specifically, the health and wellness engine 119 and/or the health and wellness platform 101 can determine whether the user takes any action in response to the presentation of the determined movement disorder, relevant health and wellness information and/or offers, etc. For example, the health and wellness engine 119 can track whether the user has clicked on the doctor's hyperlink or made an appointment in response to the determined movement disorder.

The health and wellness engine 119 optionally generates reports regarding metrics associated with, for instance, determination of movement disorder, relevant wellness information and/or offers, effectiveness of the determination of movement disorder, use interaction information, user characteristics, and other information collected and/or used by the health and wellness platform 101 or other components of the system 100 for customizing determination of movement disorder, relevant wellness information and/or offers, etc.

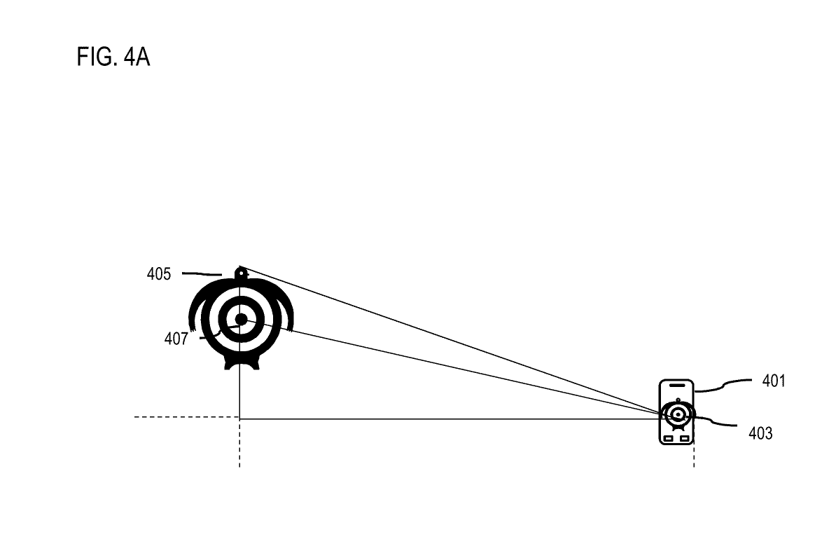

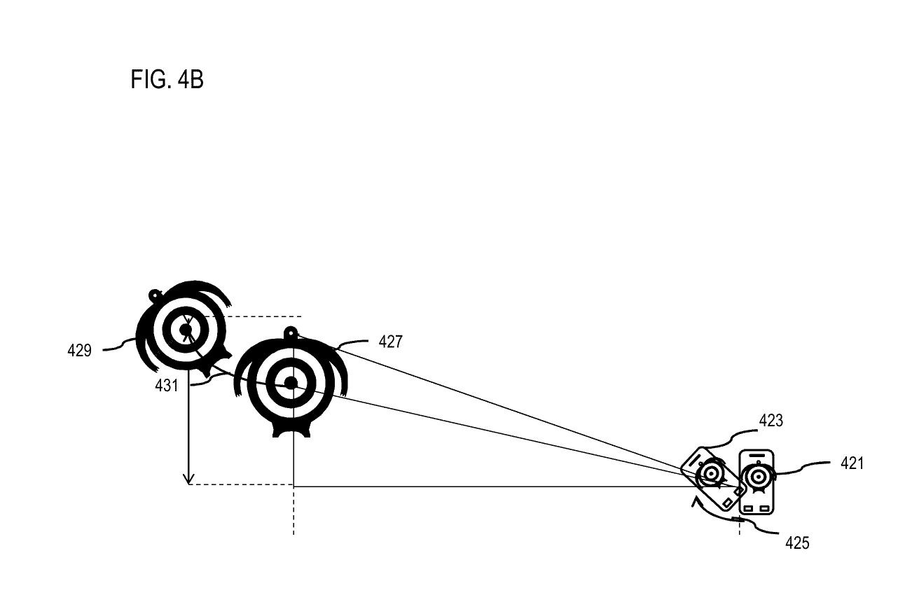

FIGS. 4A-4B are diagrams of a user device pointing at a marker utilized in the process of FIG. 3, according to various embodiments. The user interface of the UE 401 shows a marker 403 captured therein in FIG. 4A, when the camera lens points towards the center 407 of the marker 405. FIG. 4B shows how the UE follows the movement of the marker from a position 421 to a position 423 along a trajectory 425 to move from a position 427 to a position 429 along a trajectory 431.

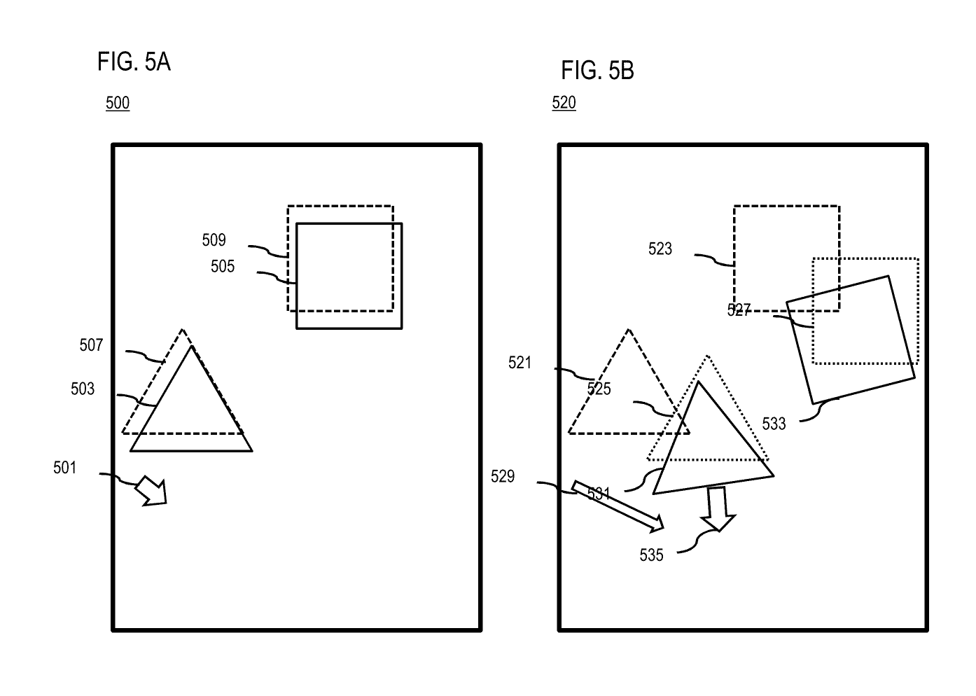

FIGS. 5A-5B are diagrams of user interfaces showing conceptual tremor in conjunction with stationary and moving markers, according to various embodiments. In reality, the tremor is more complicated and may moves in more than one direction, or even rotating, etc. FIG. 5A shows a triangle marker 503 and a square marker 505 within the user interface 500 move in parallel to a position 507 and a position 509 respectively along the arrow/vector 501 due to normal physiologic tremor of the user's hand, when the markers 503, 505 are stationary.

FIG. 5B shows a triangle marker 521 and a square marker 523 within the user interface 520 move in parallel to a position 525 and a position 527 respectively along the arrow/vector 529 due to physical movement of the user's hand to follow the moving markers. The markers further move to a position 531 and a position 533 respectively along the arrow/vector 535 due to PD tremor. The health and wellness engine 119 can remove the normal physiologic tremor of FIG. 5A and the physical movements of the markers from the tremor in FIG. 5B, to obtain PD tremor occurring when the hand is moving.

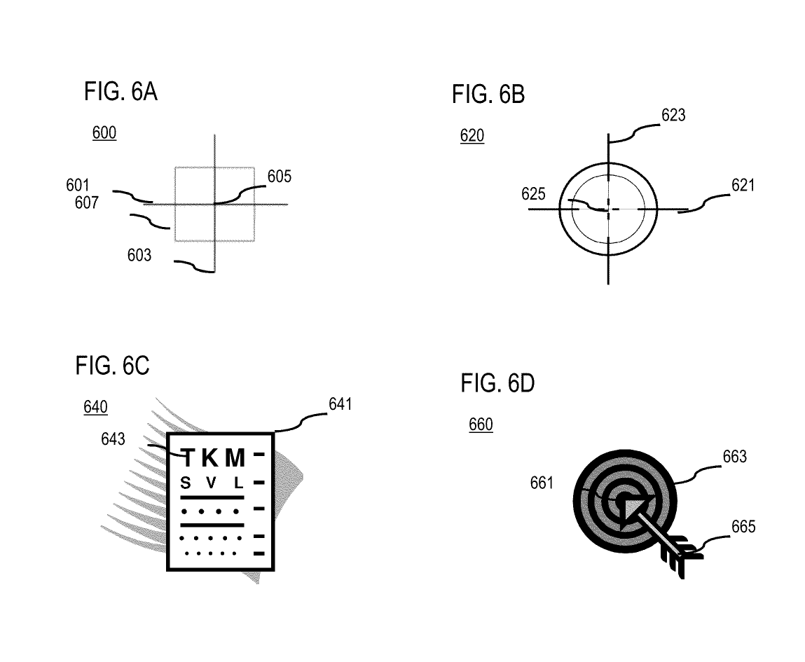

The motion detection can be simplified and enhanced, using known, specially shaped markers. FIGS. 6A-6D are diagrams of markers utilized in the process of FIG. 3, according to various embodiments. Some target shapes (e.g., crosshairs) are easier for the health and wellness engine 119 to detect movement. Some target shapes are easier for the health and wellness engine 119 to track the relative movements of the target.

FIG. 6A shows a crosshair marker 600 with an x-axis 601, a y-axis 603, a center 605, and a square box 607. FIG. 6B shows a crosshair marker 620 with an x-axis 621, a y-axis 623, a center 625, and two circles of different thicknesses. The thinner a line is, the harder it is for the user to point at and keeps the hand stable. With this marker, the health and wellness engine 119 can determine various degrees of movement disorder based on the line thicknesses.

Beside a crosshair marker, other markers come with other sizes, format, etc. specified for different types of movement disorders and relevant diseases. FIG. 6C shows an eye-vision test table marker 640 with characters 641 of various sizes. The smaller a character, the harder it is for the user to point at and keeps the hand stable. With this marker, the health and wellness engine 119 can determine various degrees of movement disorder based on the character sizes. In addition, due to the positions of the different characters, the health and wellness engine 119 can further determine various degrees of movement disorder with respect to the angle of the UE 103.

FIG. 6D shows a bull-eye marker 660 with a center 661, several circles 663, and an arrow 665. Since different parts of the marker 660 has differ thickness, the user can be asked to point at different lines, so that the health and wellness engine 119 can determine various degrees of movement disorder based on the line thicknesses.

The sampling pattern or markers may be used for an entire image comparison, a designated object comparison, a regions comparison, etc. By using the sampling pattern, the health and wellness engine 119 may sample only designated pixels. This reduces processing time and processing requirements while still providing a reliable motion determination.

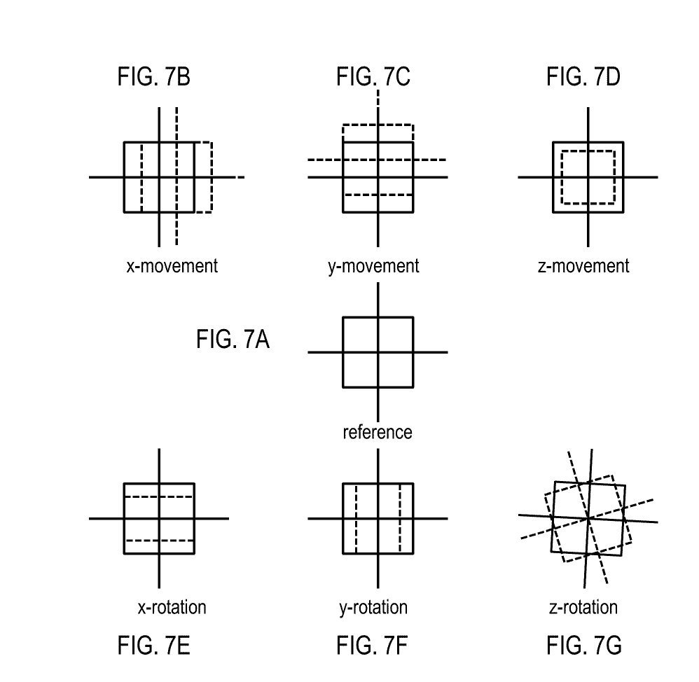

FIGS. 7A-7G are diagrams of markers utilized for detecting motions, according to various embodiments. The example markers allow detecting camera motion in all directions at the same time:
x-direction, e.g., the camera is moving left and right as shown in FIG. 7B
y-direction, e.g., the camera is moving up and down as shown in FIG. 7C
z-direction, e.g., the camera is moving closer to and farer away from the landmark as shown in FIG. 7D

In addition, the example marker allows for detecting rotation along all three axes as shown in FIGS. 7E-7G.

The above-discussed embodiments allow early detection of slight tremors that may not be visible otherwise. The test is noninvasive and hence can be performed on anyone at anytime.

The processes described herein for determining potential movement disorder using sensor data may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

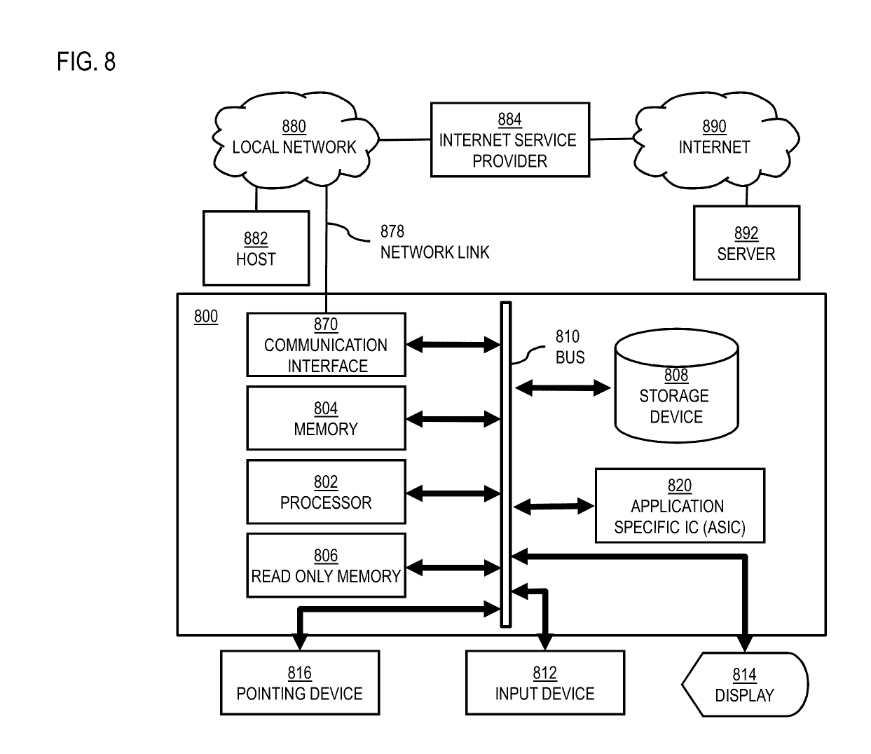

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to determine potential movement disorder using sensor data as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of determining potential movement disorder using sensor data.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to determine potential movement disorder using sensor data. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for determining potential movement disorder using sensor data. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for determining potential movement disorder using sensor data, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection from the UE 103 to the communication network 105 after determining potential movement disorder using sensor data.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to determine potential movement disorder using sensor data as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of determining potential movement disorder using sensor data.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to determine potential movement disorder using sensor data. The memory 905 also stores the data associated with or generated by the execution of the inventive steps.

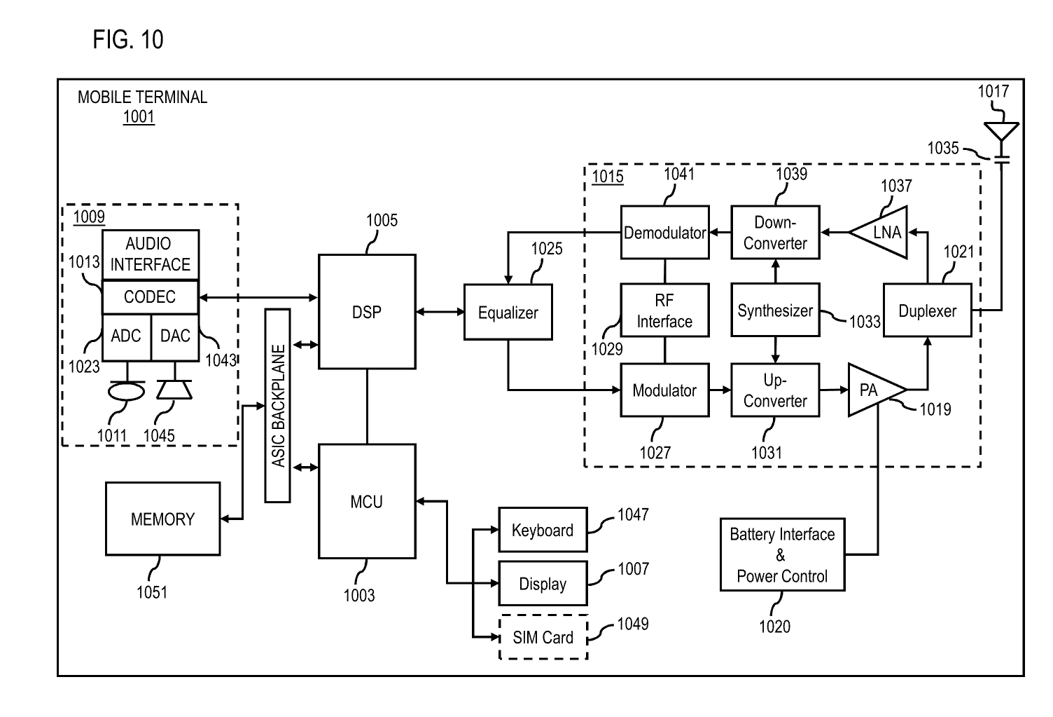

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of determining potential movement disorder using sensor data. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of determining potential movement disorder using sensor data. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to determine potential movement disorder using sensor data. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD,

ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising facilitating a processing of and/or processing (1) data and/or (2) information and/or (3) at least one signal, the (1) data and/or (2) information and/or (3) at least one signal based, at least in part, on the following:
a processing of one or more sequences of images to identify one or more reference objects, the one or more sequences of images captured via a device physically attached to a user;
movement information of the one or more reference objects within the one or more sequences of images, wherein the movement information is at least substantially attributable to one or more physical movements of the user; and
a processing of the movement information to cause, at least in part, a determination of one or more potential movement disorders associated with the user.

2. A method of claim 1, wherein the (1) data and/or (2) information and/or (3) at least one signal are further based, at least in part, on the following:
a processing of the movement information to determine a power spectrum,
wherein the determination of the one or more potential movement disorders is based, at least in part, on the power spectrum.

3. A method of claim 1, wherein the (1) data and/or (2) information and/or (3) at least one signal are further based, at least in part, on the following:
a processing of the movement information to determine at least one frequency of oscillation, at least one spectral power distribution, at least one specific range power distribution, or a combination thereof,
wherein the determination of the one or more potential movement disorders is based, at least in part, on the at least one frequency of oscillation, at least one spectral power distribution, at least one specific range power distribution, or a combination thereof.

4. A method of claim 1, wherein the (1) data and/or (2) information and/or (3) at least one signal are further based, at least in part, on the following:
a comparison of the movement information against one or more criteria associated with the one or more potential movement disorders, wherein the determination of the one or more potential movement disorders is based, at least in part, on the comparison.

5. A method of claim 1, wherein the movement information includes, at least in part, one or more acceleration measurements, one or more velocity measurements, or a combination thereof of the one or more reference objects with respect to any one or more axis of movement.

6. A method of claim 1, wherein the (1) data and/or (2) information and/or (3) at least one signal are further based, at least in part, on the following:
a capture of the one or more sequences of images following a completion of one or more physical activities by the user.

7. A method of claim 6, wherein the (1) data and/or (2) information and/or (3) at least one signal are further based, at least in part, on the following:
other movement information associated with the one or more physical activities, a control state of the user, or a combination thereof; and
at least one determination to normalize for the other movement information in the determination of the movement information.

8. A method of claim 1, wherein the (1) data and/or (2) information and/or (3) at least one signal are further based, at least in part, on the following:
at least one determination of previously stored movement information associated with the user,
wherein the determination of the one or more potential movement disorders is further based, at least in part, on the previously stored movement information.

9. A method of claim 1, wherein the one or more reference objects include, at least in part, one or more stationary reference objects, one or more moving reference objects with a known pattern of movement, or a combination thereof.

10. A method of claim 1, wherein the one or more reference objects have one or more predetermined shapes, one or more predetermined configurations, or a combination thereof.

11. An apparatus comprising:
at least one processor; and
at least one memory including computer program code for one or more programs,
the at least one memory and the computer program code configured to, with the at least one processor, cause the apparatus to perform at least the following,
process and/or facilitate a processing of one or more sequences of images to identify one or more reference objects, the one or more sequences of images captured via a device physically attached to a user;
determine movement information of the one or more reference objects within the one or more sequences of images, wherein the movement information is at least substantially attributable to one or more physical movements of the user; and
process and/or facilitate a processing of the movement information to cause, at least in part, a determination of one or more potential movement disorders associated with the user.

12. An apparatus of claim 11, wherein the apparatus is further caused to:
process and/or facilitate a processing of the movement information to determine a power spectrum,
wherein the determination of the one or more potential movement disorders is based, at least in part, on the power spectrum

13. An apparatus of claim 11, wherein the apparatus is further caused to:
process and/or facilitate a processing of the movement information to determine at least one frequency of oscillation, at least one spectral power distribution, at least one specific range power distribution, or a combination thereof,
wherein the determination of the one or more potential movement disorders is based, at least in part, on the at least one frequency of oscillation, at least one spectral power distribution, at least one specific range power distribution, or a combination thereof.

14. An apparatus of claim 11, wherein the apparatus is further caused to:
cause, at least in part, a comparison of the movement information against one or more criteria associated with the one or more potential movement disorders,
wherein the determination of the one or more potential movement disorders is based, at least in part, on the comparison.

15. An apparatus of claim 11, wherein the movement information includes, at least in part, one or more acceleration measurements, one or more velocity measurements, or a combination thereof of the one or more reference objects with respect to any one or more axis of movement.

16. An apparatus of claim 11, wherein the apparatus is further caused to:
cause, at least in part, a capture of the one or more sequences of images following a completion of one or more physical activities by the user.

17. An apparatus of claim 16, wherein the apparatus is further caused to:
determine other movement information associated with the one or more physical activities, a control state of the user, or a combination thereof; and
determine to normalize for the other movement information in the determination of the movement information.

18. An apparatus of claim 11, wherein the apparatus is further caused to:
determine previously stored movement information associated with the user,
wherein the determination of the one or more potential movement disorders is further based, at least in part, on the previously stored movement information.

19. An apparatus of claim 11, wherein the one or more reference objects include, at least in part, one or more stationary reference objects, one or more moving reference objects with a known pattern of movement, or a combination thereof.

20. An apparatus of claim 11, wherein the one or more reference objects have one or more predetermined shapes, one or more predetermined configurations, or a combination thereof.

21-48. (canceled)
